(19) United States
(12) Patent Application Publication
(10) Pub. No.: US 2002/0119774 A1
(43) Pub. Date: Aug. 29, 2002

(54) Method for PLMN selection

(76) Inventors: Regina Johannesson, Lund (SE); Anne-Lott Hedberg, Lund (SE)

Correspondence Address: JENKENS & GILCHRIST, P.C., 1445 Ross Avenue, Suite 3200, Dallas, TX, 75202-2799, US

(21) Appl. No.: 09/849,086

(22) Filed: May 4, 2001

Related U.S. Application Data
(60) Provisional application No. 60/271,937, filed on Feb. 26, 2001.

(51) Int. Cl. H04Q 7/20

(52) U.S. Cl. 455/434; 455/552; 455/435; 455/432

(57) ABSTRACT

A method for selecting a public land mobile network to serve a mobile station includes the step of receiving at the mobile station a list of data associated with networks neighboring the PLMN currently serving the mobile station. A new PLMN to serve the mobile station is selected based upon the list of data, and the mobile station changes to the selected new PLMN.

### RELATED APPLICATION(S)

This application is a Continuation-in-Part of, and incorporates herein by reference, the entire disclosure of U.S. Provisional Application No. 60/271,937 filed Feb. 26, 2001.

### TECHNICAL FIELD

The present invention relates to the selection of public land mobile networks (PLMNs) for serving a mobile station, and more particularly, to selecting PLMNs to improve mobile station battery life and connection efficiencies.

### BACKGROUND OF THE INVENTION

Existing standards require a mobile station (MS) to locate a best possible public land mobile network (PLMN) for serving the mobile station by performing a PLMN selection process. This process involves the mobile station scanning for a PLMN other than the registered PLMN (RPLMN) which is presently serving the mobile station. This reselection of a PLMN by mobile station is initiated by the mobile station moving outside of coverage area of the RPLMN presently serving the mobile station or by expiration of a home public land mobile network (HPLMN) timer. Expiration of the HPLMN timer causes the mobile station to search for its home public land mobile network.

The problem with the present standard for selecting PLMNs for a mobile station arises when the mobile station moves to an area where a better PLMN for serving mobile station may be available, but the mobile station still resides within the coverage area of its presently serving RPLMN. In this situation the mobile station will stay within the coverage area of the RPLMN even though a better choice of PLMN is available. Also, under the present standard the mobile station is required to search for the HPLMN every time the HPLMN timer expires, this can cause an unnecessary drain upon the battery power of the mobile station. For example, if the HPLMN of the mobile station is presently not located near the mobile station, the search will be done even though there is no chance of locating the HPLMN. Additionally, the mobile station can come into range of the HPLMN and reassignment to the HPLMN would be delayed until expiration of the HPLMN timer. Likewise, when a mobile station is located near the border of a country wherein a first PLMN serves the first country and another PLMN serves the second country, the mobile station may get caught being served by a non-HPLMN when their HPLMN is just across the border from them, but they are still within the coverage area of their serving PLMN.

Thus, some method for improving the manner in which to select a PLMN serving a mobile station would be greatly desirable in terms of reduced demands put upon the battery power of the mobile station and insuring more efficient utilization of available PLMN resources by the mobile station.

### SUMMARY OF THE INVENTION

The present invention overcomes the foregoing and other problems with a method for selecting a public land mobile network to serve a mobile station. The mobile station receives a list of data associated with networks neighboring the PLMN currently serving the mobile station from a base station of the PLMN currently serving the mobile station. Using this list of data which may comprise a list of neighboring PLMNs, at least one mobile country code of neighboring networks, or any other type of data relating to the neighboring networks of the serving PLMN, the mobile station selects a new PLMN to serve the mobile station. Once the mobile station has selected a new PLMN responsive to the provided list of data, the mobile station may change to the selected new PLMN.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 illustrates a mobile station located within one of a plurality of public land mobile networks;

FIG. 2 is a block diagram illustrating a mobile station and a base station communicating via a wireless link and including the additional information relating to neighboring PLMNs according to the present invention;

FIG. 3 is a flow diagram describing one method for selecting a new PLMN based upon a provided PLMN neighbor list;

FIG. 4 is a flow diagram illustrating a method for determining a proximity to a home public mobile land network based upon provided mobile country codes; and

FIG. 5 is an example of a situation for use of the MCC list.

### DETAILED DESCRIPTION

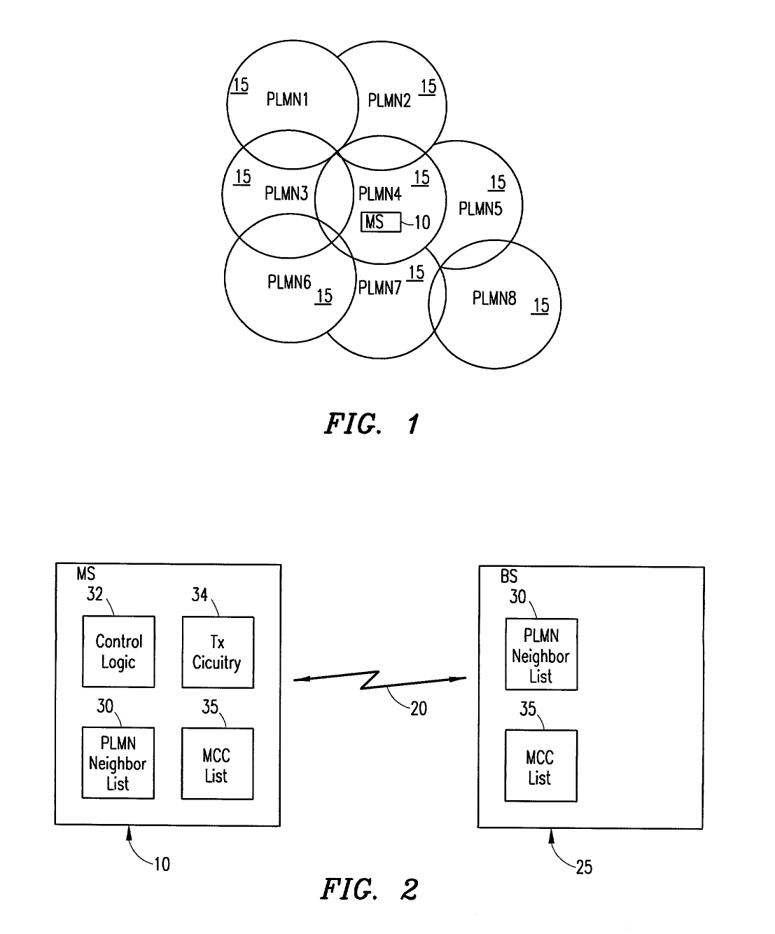

Referring now to the drawings, and more particularly to FIG. 1, there is illustrated a mobile station 10 which is located within one PLMN 15 of a plurality of adjacent PLMNs 15. Within FIG. 1, the mobile station 10 is located within PLMN 4. PLMN 4 comprises the registered PLMN (RPLMN) of mobile station 10. In the present example, it is assumed that the home PLMN (HPLMN) of the mobile station 10 is PLMN 1. The mobile station 10 and PLMNs 15 could be utilized within any number of wireless communication systems including, but not limited to, the global system for mobile communications (GSM), a general packet radio system (GPRS), a universal mobile telecommunication system (UNMTS), a personal communication system (PCS) and Digital Advanced Mobile Phone System (D-AMPS).

Within present standards, the mobile station 10 would be required to scan and search for a better PLMN to provide service to the mobile station 10 upon the occurrence of certain criteria such as movement of the mobile station 10 from PLMN 4 to one of the other PLMNs or expiration of the HPLMN timer. In order to improve upon this system, rather than continuously or periodically scanning for a better PLMN 15 to serve the mobile station 10, the PLMN 15 currently serving the mobile station 10 may periodically transmit various information on neighboring PLMNs of the presently serving PLMN as illustrated in FIG. 2.

FIG. 2 illustrates a mobile station 10 having a wireless communications link 20 with a base station 25 of a serving PLMN 15. The information included at the base station 25 transmitted to the mobile station 10 via the wireless communications link 20 enables the selection of the PLMN serving the mobile station 10 and includes a neighbor list 30 and a mobile country code (MCC) list 85. These lists may be available individually or together. A neighbor list 30 includes a list of each PLMN neighboring the PLMN presently serving the mobile station 10. Thus, in the example of FIG. 1, the base station 25 within PLMN 4 would transmit a list to the mobile station 10 including PLMN 2, PLMN 3, PLMN 5, PLMN 6 and PLMN 7. Additionally, the neighbor list 30 may include PLMNs within a certain distance of the serving PLMN 15 rather than only adjacent PLMNs. In these circumstances, PLMN 1 and PLMN 8 could also be included within the neighbor list 30 of PLMN 4. The neighbor list 30 may either be generally broadcast from the base station 25 or selectively transmitted to a mobile station 10, for example, during registration of the mobile station with serving PLMN 15. In addition to the identity of neighborhood PLMN networks, the neighbor list 30 could be extended to include access technology information which is essential for the selection of the PLMN in, for example, a UMTS network.

Alternatively, or in addition to, the base station may transmit a mobile country code (MCC) list 35 to the mobile station 10 via the wireless link 20. The MCC list 35 includes the list of MCCs of countries located near the PLMN 15 presently serving the mobile station 10. Thus, the MCC list 35 may be empty or inactive if the base station 25 is not located in a border area and there are no foreign PLMNs within other countries in or near the coverage area of the base station 25. Like the neighbor list 30, this information may be continuously transmitted from the base station 25 or may be periodically provided to the mobile station 10 during, for example, registration of the mobile station with the serving public land mobile network 15. Alternatively, the MCC list 35 could be transmitted to the mobile station 10 any time the mobile station 10 accesses the PLMN 15 within existing message protocols such as an MM information message, SMS message or in messages specifically defined for the purposes of transmitting this information. Alternatively, the MCC list 35 could be transmitted to the mobile station by means of the SIM toolkit or other messaging systems.

Control logic 32 enables processing of information within the PLMN neighbor list 30 to determine and select a better PLMN, if available, and processing of information in the MCC list 35 to determine the availability of and enable selection of a preferred PLMN. Transceiver circuitry 34 provides for the wireless line 20 between the mobile station 10 and the base station 25.

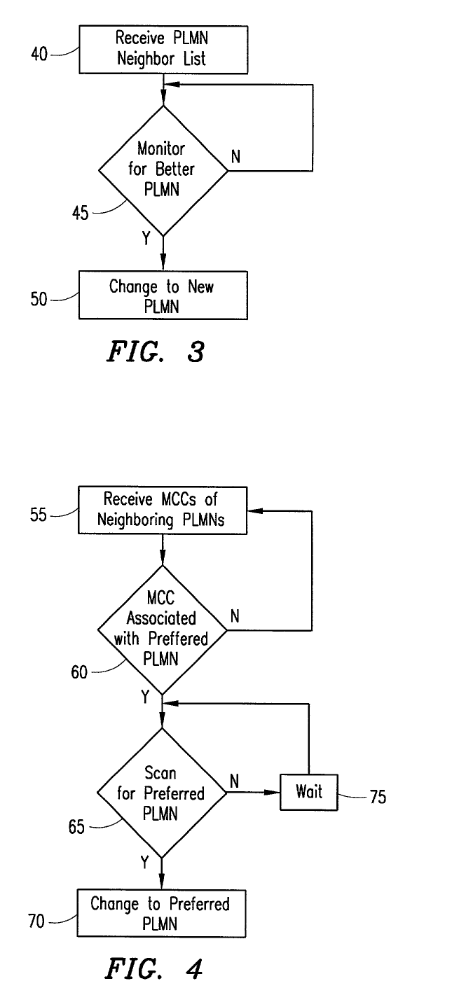

Referring now to FIG. 3, there is illustrated one manner in which the provided neighbor list 30 may be utilized by a mobile station 10 according to the present invention. The mobile station 10 receives at step 40 the PLMN neighbor list 30 from the base station 25. Logic 32 in the mobile station 10 analyses the provided neighbor list 30 at inquiry step 45 to monitor for a better PLMN 15 to serve the mobile station 10. Criteria for determining a better PLMN 15 may include a user preferred PLMN, an operator preferred PLMN, the home PLMN, etc. Thus, rather than periodically scanning for new PLMN based upon the expiration of an HPLMN timer, the scanning will only take place when a better PLMN is determined to be available by logic 32. This conserves a battery power of mobile station 10 since no unnecessary scanning will be done. PLMN reselection will also be done as soon as a better PLMN appears, since the election of a new PLMN will not have to wait upon the expiration of the HPLMN timer which may be anywhere from 6 minutes to 1,536 minutes. Thus, more efficient use of available PLMNs by the mobile station is provided. Once a better PLMN for the mobile station is located, the mobile station switches at step 50 to the newly located PLMN by scanning for the selected PLMN and switching to the PLMN once found. Otherwise, inquiry step 45 continues to monitor for a better PLMN to serve the mobile station 10.

Referring now to FIG. 4, there is a flow diagram illustrating the manner in which the MCC list 35 may be used by a mobile station 10 in selecting a PLMN 15. A mobile station receives at step 55 the mobile country codes of neighboring countries. Control logic 32 uses the provided mobile country codes to determine at inquiry step 60 whether a preferred public land mobile network of the mobile station 10 (for example, a home PLMN) is associated with one of the provided mobile country codes. Once inquiry step 60 determines that the HPLMN is associated with one of the provided mobile country codes, the mobile station searches at step 65 for the home PLMN by scanning for the PLMN. The search could be initiated by a timer (not shown) responsive to a match between the provided MCC and an MCC of a preferred PLMN. Once the preferred PLMN is found, the mobile station changes to the preferred PLMN at step 70. If the preferred PLMN is not found, the mobile station waits a selected period of time at step 75 and returns to scanning at step 65. If the MCC is not associated with the preferred PLMN, the mobile station returns to step 55 and continues to receive an updated MCC list 35.

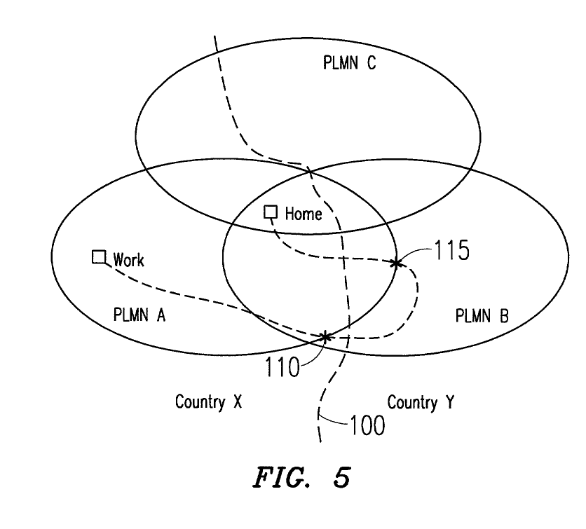

The MCC list 35 would be useful in a situation such as that illustrated with respect to FIG. 5. Here, three PLMNs are illustrated which straddle the border 100 between country X and country Y. A user traveling from work 105 located in PLMN A, his home PLMN, would cross from PLMN A into PLMN B when travelling home. At point 110 the mobile station would leave the coverage area of PLMN A and be served by PLMN B. At point 115, the mobile station would enter back into the coverage area of his home PLMN A but would still be within the coverage area of PLMN B. Plan B would provide the MCC of country A to the mobile station being served within PLMN B, such that the mobile station could search for and switch back to his home PLMN when the mobile station reenters the coverage area of PLMN A at point 115 using the above described process.

Using the above described method, a mobile station may more efficiently select a PLMN to serve the mobile station without unnecessary scanning which reduces the battery power of the mobile station and may more quickly and efficiently select the appropriate PLMN to serve the mobile station.

The previous description is of a preferred embodiment for implementing the invention, and the scope of the invention should not necessarily be limited by this description. The scope of the present invention is instead defined by the following claims.

What is claimed is:

1. A method for selecting a public land mobile network to serve a mobile station, comprising the steps of:
receiving at the mobile station a list of data associated with networks neighboring a PLMN currently serving the mobile station;
selecting a new PLMN to serve the mobile station from the PLMNs neighboring the PLMN currently serving the mobile station based upon the list of data; and
changing the mobile station to the selected new PLMN.

2. The method of claim 1, wherein the list of data further comprises a list of PLMNs neighboring the PLMN currently serving the mobile station.

3. The method of claim 1, wherein the list of data further comprises a list of PLMNs adjacent to the PLMN currently serving the mobile station.

4. The method of claim 1, wherein the list of data further comprises a list of PLMNs within a selected distance of the PLMN currently serving the mobile station.

5. The method of claim 1, wherein the list of data further comprises at least one mobile country code associated with a network neighboring the PLMN currently serving the mobile station.

6. The method of claim 5, wherein the step of selecting further comprises the step of:
determining if the at least one mobile country code is associated with a preferred PLMN of the mobile station; and
selecting the preferred PLMN of the mobile station as the new PLMN if the mobile country code is associated with the preferred PLMN.

7. The method of claim 5, wherein the preferred PLMN comprises a home PLMN of the mobile station.

8. The method of claim 1, wherein the step of receiving occurs only near a border of a country.

9. The method of claim 1, wherein the step of receiving occurs on a periodic basis.

10. The method of claim 1, wherein the step of receiving occurs on a substantially continuous basis.

11. The method of claim 1, wherein the step of receiving occurs during registration of the mobile station with a PLMN.

12. The method of claim 1, wherein the step of receiving further comprises the step of receiving the list of data in a MM information message.

13. A method for selecting a PLMN to serve a mobile station comprising the steps of:
transmitting from a base station associated with a serving PLMN to the mobile station a list of neighboring PLMNs;
selecting a new PLMN from the list of neighboring PLMNs as a new PLMN to serve the mobile station; and
changing the mobile station to the new PLMN.

14. The method of claim 13, wherein the list of neighboring PLMNs further comprises a list of PLMNs adjacent to the PLMN currently serving the mobile station.

15. The method of claim 13, wherein the list of neighboring PLMNs further comprises a list of PLMNs within a selected distance of the PLMN currently serving the mobile station.

16. The method of claim 13, wherein the step of transmitting occurs on a periodic basis.

17. The method of claim 13, wherein the step of transmitting occurs on a substantially continuous basis.

18. The method of claim 13, wherein the step of transmitting occurs during registration of the mobile station with the serving PLMN.

19. The method of claim 13, wherein the list of neighboring PLMNs further includes access technology.

20. The method of claim 13, wherein the step of selecting further comprises the steps of:
determining a better PLMN exists for serving the mobile station from the list of neighboring PLMNs; and
scanning for the better PLMN.

21. The method for selecting a preferred PLMN to serve a mobile station, comprising the steps of:
transmitting from a base station associated with a serving PLMN to the mobile station at least one mobile country code associated with a neighboring network;
selecting the preferred PLMN as a new serving PLMN if the at least one mobile country code is associated with the preferred PLMN;
scanning for the preferred PLMN; and
changing the mobile station to the preferred PLMN.

22. The method of claim 5, wherein the step of selecting further comprises the step of:
determining if the at least one mobile country code is associated with the preferred PLMN of the mobile station; and
selecting the preferred PLMN of the mobile station as the new PLMN if the mobile country code is associated with the preferred PLMN.

23. The method of claim 21, wherein the step of receiving further comprises the step of receiving the list of data in a MM information message.

24. The method of claim 21, wherein the preferred PLMN comprises a home PLMN of the mobile station.

25. The method of claim 1, wherein the step of transmitting further comprises the step of transmitting from a base station near a border between first and second countries.

26. A mobile terminal comprising:
circuitry for wirelessly connecting the mobile terminal to a serving PLMN network;
a neighbor list containing data received from the serving PLMN enabling selection of a PLMN neighboring the serving PLMN as a new serving PLMN; and
control logic for selecting the new serving PLMN responsive to the data of the neighbor list.

27. The mobile terminal of claim 26, wherein the neighbor list further includes a list of PLMNs neighboring the serving PLMN.

28. The mobile terminal of claim 26, wherein the neighbor list further includes a list of PLMNs adjacent to the PLMN currently serving the mobile station.

29. The mobile terminal of claim 26, wherein the neighbor list further includes a list of PLMNs within a selected distance of the PLMN currently serving the mobile station.

30. The mobile terminal of claim 26, wherein the neighbor list further includes at least one mobile country code of a neighbor network of the PLMN currently serving the mobile station.
